(19) United States
(12) Patent Application Publication
(10) Pub. No.: US 2008/0110331 A1
(43) Pub. Date: May 15, 2008

(54) CAM RING FOR AN INJECTION PUMP

(75) Inventors: Wolfgang Bickle, Reilingen (DE); Ruediger Bickle, Reilingen (DE); Uwe Nigrin, Ilmenau (DE)

Correspondence Address: BRINKS HOFER GILSON & LIONE, P.O. BOX 10395, CHICAGO, IL, 60610, US

(73) Assignees: KS Gleitlager GmbH, St. Leon-Rot (DE); Siemens AG CT IP SAM, Munchen (DE)

(21) Appl. No.: 12/017,494

(22) Filed: Jan. 22, 2008

Related U.S. Application Data
(63) Continuation of application No. PCT/EP2006/006888, filed on Jul. 14, 2006.

(30) Foreign Application Priority Data
Jul. 21, 2005 (DE) 10 2005 035 082.8

(51) Int. Cl. F16J 1/10

(52) U.S. Cl. 92/129

(57) ABSTRACT

The invention relates to a cam ring (2) for an injection pump for an internal combustion engine, comprising a round opening (4) for a shaft section, which can be eccentrically driven, and comprising a flattened outer section (6) against which a displacer element of the injection pump can be supported. A bush-shaped low-friction bearing means (12) for mounting the shaft section is provided inside the opening (4) of the cam ring (2). In order to reduce the problematic effects of pressing in the low-friction bearing means into the opening, the cam ring is designed so that the low-friction bearing means (12) in one form comprises a polymer-based bearing coating material (14) with friction-reducing fillers, which is directly placed upon the surface (16) of the cam ring (2) that delimits the opening (4).

### CROSS-REFERENCE TO RELATED APPLICATIONS

This application is a continuation of International Application No. PCT/EP2006/006888 filed on Jul. 14, 2006, which claims the benefit of DE 10 2005 035 082.8, filed Jul. 21, 2005. The disclosures of the above applications are incorporated herein by reference.

### FIELD

The invention relates to injection pumps for an internal combustion engines.

### BACKGROUND

The statements in this section merely provide background information related to the present disclosure and may not constitute prior art.

In the case of known cam rings, the low-friction bearing means is designed in the form of a plain bearing bushing that is made of steel/plastic composite. It comprises a support layer made of steel (steel back) and a porous carrier layer, which is usually made of bronze, into whose pores a polymer-based sliding-layer material is introduced. These kinds of plain bearing bushings are produced from an endless strip material, from which the blanks are cut and rolled, so that they form a butt joint. They are pressed into the opening of the cam ring with minimum compression force, so that they retain a tight fit during operation of the injection pump under all operating conditions and do not disengage in the opening. Pressing in bearing bushings of this type leads, on the one hand, to surface pressure between the impacting ends of the bushing, which acts in the circumferential direction of the bushing in the bushing material. On the other hand, a radial force is exercised in this way on the material of the cam ring, which leads to a radial curvature of the flattened outer sections, so that the flattened outer section, seen in cross section in the direction of the longitudinal central axis of the opening, or as the case may be, the bushing is no longer even, but rather runs in a warped, arched way, and displays a peak. When the foot or shoe section of a displacer element rests against this warped surface, there is no longer the guarantee of an even application of force to the displacer element via this bearing surface. There is no longer a sufficiently even surface contact. There is rather a linear or punctual application of force. This is accompanied by a higher rate of wear and material fatigue.

### SUMMARY

The present invention is based on the task of dealing with this conflict of objectives, i.e., on the one hand, to ensure a tight fit of the low-friction bearing means in the opening of the cam ring, and on the other hand, to ensure an application of force by the cam ring on the displacement element that is resistant to fatigue and wear.

This task is inventively accomplished through a cam ring of the cited type in that the low-friction bearing material in one form is comprised of a polymer-based sliding-layer material with friction-reducing filler material, which is applied directly to the surface of the cam ring that delimits the opening.

By applying the sliding-layer material directly to the surface of the cam ring that delimits the opening, and by dispensing with a steel back as the carrier of the sliding-layer material, or to put it another way, if the cam ring itself is now used as the carrier or supporting body for the sliding-layer material, the cause of the problem of too rapid fatiguing and too high a rate of wear, which is the outward arching of the cam ring as a result of the high inward pressure of the plain bearing bushing, can be eliminated. When the sliding-layer material, according to a preferred embodiment of the invention, is sprayed onto the surface, or according to a further embodiment, a film-like material is made from the sliding material and applied directly to the surface using an adhesion-favoring agent, particularly one based on PFA (perfluoralkoxy copolymer), there is no longer any significant radial pressure that would arch the cam ring, or as the case may be, the even outer section.

It has proved advantageous when the surface that delimits the opening of the cam ring has, for this purpose, a surface roughness of at least R_{z}4, in particular of at least R_{z}6, and furthermore, preferably at least R_{z}8.

In a further development of this inventive idea, it is seen as advantageous to phosphatize the surface as well.

According to a further inventive idea, it proves advantageous, if the surface is roughened, for example by way of being shot-blasted. It has been shown that this not only produces an advantageous surface roughness, which assures good adhesion of the sliding-layer material, but in addition, the surface is also compacted due to the pulsed pressure of the spraying process, thereby hardening it. The surface is therefore better suited to absorb tangentially acting forces (shear forces), or as the case may be, to resist shear stress and to retain the sliding-layer material on the surface of the opening.

The present disclosure provides further advantages. Because a metal support, or as the case may be, a carrier layer can be dispensed with, radial installation space is saved, which means that the cam ring can be more compactly designed with the same external dimensions. Correspondingly, the radial depth of the installation space that is not used up by the metal carriers can be used to increase the thickness of the sliding-layer material.

On the whole, an injection pump can be produced for the highest stresses, including mixed friction, in the inventive manner, like when starting the assembly. The cam ring is also suitable for use, for example, in high-pressure injection pumps with direct-injection, diesel engines in the pressure range 1000 to 2000 bar, where the demands are not comparable to those of conventional gasoline engines, where operation is between 200 and 300 bar.

According to one form of the inventive cam ring, the sliding-layer material is produced on the basis of PEEK (polyether ether ketone). This means, that at least about 50 percent by volume of the polymer share comprises PEEK. The sliding-layer material as a whole, i.e. including the filler materials, is preferably comprised of at least about 50 percent PEEK by weight. As a wear-resistant, filler material, the sliding-layer material will also comprise in one form about 5 to about 15 percent TiO₂ by weight. It will also comprise about 5 to about 15 percent by weight of zinc sulfide and/or barium sulfate, which produces an outstanding solid lubricant, particularly for conditions of mixed friction. It has also proven advantageous to have the sliding-layer material comprise about 5 to about 15 percent graphite by weight. It has also proven advantageous if it contains about 5 to about 15 percent carbon fibers by weight.

Zinc sulfide is a good solid lubricant that is inured to dryness. Graphite, however, which is more sensitive in this respect, has good heat-conduction and is able to dissipate the frictional heat in the direction of the bearing-metal layer and metal support layer. Titanium dioxide, on the other hand, gives the required resistance to wear. Therefore, with these components, a suitable system is created in tribological terms as well, even with conditions of fixed friction (high load, the occurrence of frictional heat, dryness). Carbon fibers support the dissipation of frictional heat and provide stability in the direction of the surface.

It has proved particularly practical, if the sliding-layer material has a layer thickness of about 100 to about 250 μm, whereby this concerns the thickness of the layer in the finished cam ring. During the first stage of production, a layer with a machining allowance of approximately 150 μm is applied, therefore having a thickness of about 250 to about 400 μm, which is then reduced to the cited range during final cutting and calibration.

According to a further embodiment of the inventive cam ring, the sliding-layer material comprises a PAI (polyamide-amide) based lubricating varnish. In such cases, a layer about 15 to about 50 μm thick is applied, in particular about 15 to about 25 μm thick, without machining allowance/tolerances, in particular by spraying on the material or by immersion.

A preferred composition of the inventive sliding-layer material comprises about 60 percent PEEK by weight, about 10 percent graphite by weight, about 10 percent carbon fibers by weight, about 10 percent TiO₂ by weight, and about 10 percent ZnS by weight.

A preferred composition of the lubricating varnish comprises about 60 PAI by weight, about 10 percent graphite by weight, about 10 percent carbon fibers by weight, about 10 percent TiO₂ by weight, and about 10 percent ZnS by weight; examples of execution with carbon fibers have also proved practical.

According to a further inventive idea, the surface of the cam ring that delimits the opening features a macroscopic surface contouring which forms undercuts in the circumferential direction, and in that way helps compress the sliding-layer material. With macroscopic surface contouring of this kind, tangentially arising shear forces that attempt to detach the low-friction bearing means during operation can be better absorbed, so that a tight fit of the low-friction bearing means in the opening is guaranteed under all operating conditions. This kind of macroscopic surface contouring comprises, for example, recesses or web-shaped elevations that can run in the longitudinal direction of the bushing-shaped opening or at an incline to it, particularly in helical form.

It is also conceivable for the surface contouring to be configured as a knurled pattern, which preferably extends essentially over the entire surface of the cam ring that delimits the opening.

Another independent inventive idea, which requires independent protection, provides for a polymer-based sliding-layer material with friction-reducing filler materials to be applied directly to a surface on the flattened outer section of the cam ring, said material essentially forming a contact surface for the displacer element. This design, which is entitled to independent protection, can be realized instead of, or in addition to, the inventive design for the low-friction bearing means in the opening of the cam ring. It has been demonstrated, that the detrimental effects of the minor arching of the cam ring can be compensated for by using this kind of modification of the flattened outer section.

In a further development of this inventive idea, the sliding-layer material can feature a layer-thickness of about 100 to about 250 μm and be more or less plate-shaped. A plate-shaped recess in the flattened outer section of the cam ring can also be provided for this purpose, into which the sliding-layer material is placed in a more or less flush-mounted manner.

At least in principle, it would also be conceivable that instead of, or in addition to this measure, a section of the cam ring facing the section of the displacer element would feature this kind of coating of sliding-layer material.

The design and composition of the sliding-layer material applied to the flattened outer section of the cam ring can advantageously correspond to the composition of the sliding-layer material described above.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

In order that the invention may be well understood, there will now be described an embodiment thereof, given by way of example, reference being made to the accompanying drawing, in which:

FIG. 1 is a view of the inventive cam ring seen in the direction of the longitudinal axis;

FIG. 2 is a sectional view with section planes II-II from FIG. 1;

FIG. 3 is a perspective view of a further variant of execution of the inventive cam ring (before coating the opening); and

FIG. 4 is a perspective view of a further embodiment of a cam ring according to the present disclosure.

### DETAILED DESCRIPTION

The following description is merely exemplary in nature and is not intended to limit the present disclosure, application, or uses.

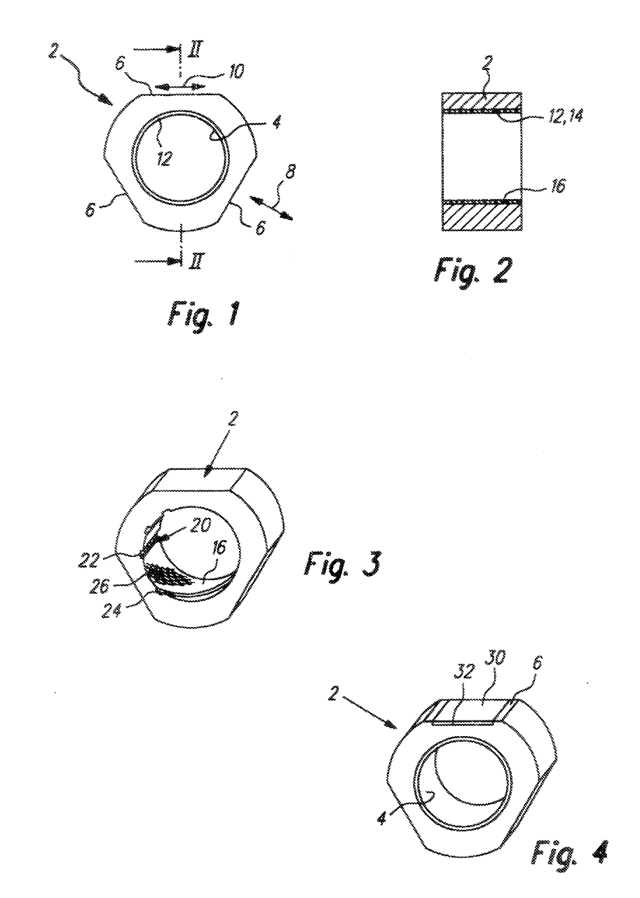

FIGS. 1 and 2 show two views of an inventive cam ring 2, particularly for use in a high-pressure injection pump of a diesel internal combustion engine. The cam ring 2 is compact and has a cylindrical shape in the widest sense. It features a central opening 4 for a shaft section driven in a slightly eccentric manner. On its outer circumference, the cam ring 2 features three flattened, level, outer sections 6, against each of which a displacer element (piston element) can rest. With the slightly eccentric drive of the aforementioned shaft section, each displacement element respectively is moved back and forth in the direction of the double arrow 8, whereby a foot section that rests against the outer section 6 of the respective displacement element executes a sliding movement, back and forth, in the planar direction of the flattened outer section 6 opposite to it (see double arrow 10).

In the opening 4 of the cam ring, a low-friction bearing means 12 is provided for mounting the eccentrically driven shaft section, which is not shown. The inventive low-friction bearing means 12 is not a rolled plain bearing bus with a metallic carrier layer that would be pressed into the opening but instead comprises a polymer-based sliding-layer material 14 with friction-reducing filler materials, said sliding-layer material being directly applied to the surface 16 of the cam ring 2 that delimits the opening 4. For this purpose, according to a preferred embodiment of the invention, the surface 16 can be roughened beforehand, particularly by shot-blasting it. A surface roughness of at least R_{z}8, in particular of R_{z}10 has proven particularly advantageous. In addition, the previously roughened surface can also be phosphatized. Then the polymer-based low-friction material forming the sliding surface can also hold very well even with shearing stress on the surface 16 in the direction of the circumference of the can ring 2. The low-friction material forming the sliding surface can advantageously be sprayed onto the surface. It is also conceivable, however, that a film-like substance can be made of it, which is then applied to the surface, in particular by adhesive bonding.

The thickness of the layer of low-friction material 12 applied to the sliding surface in a radial direction amounts particularly to 100 to 250 μm after calibration; originally a layer with an additional machining allowance of an extra 150 μm was applied.

A preferred sliding-surface material that can be applied by spraying comprises, for example, 60 percent by weight of PEEK, 10 percent by weight of graphite, 10 percent by weight of carbon fibers, 10 percent by weight of TiO₂ and 10 percent by weight of ZnS.

According to an additional variant of the invention, a PAI-based lubricating varnish can be sprayed on in a layer 15 to 45 μm thick, in particular 15 to 25 μm, without a machining allowance. An exemplary and preferred composition of the lubricating varnish is comprised of 60 percent by weight of PAI, 10 percent by weight of graphite, 10 percent by weight of carbon fibers, 10 percent by weight of TiO₂, and 10 percent by weight of ZnS.

FIG. 3 shows a corresponding cam ring 2, on whose inner surface 16, a macroscopic surface contouring 20 is provided in the form of recesses 22 running in a longitudinal direction. Alternatively, or in addition to this, examples are shown of a helical recess 24 and a knurled 26 pattern on the surface. These measures make it possible to design undercuts, singly or in combination, in a tangential direction, or as the case may be, in a circumferential direction, for the sliding-surface material applied, so that said surface can better absorb shear stress and transfer it to the cam ring 2, without the low-friction material becoming detached from the surface 16.

Finally, FIG. 4 shows a further embodiment of the invention, in which on one flattened outer section 6 a thin layer of polymer-based low-friction material 30 has been applied directly to the sliding surface. As can be seen from FIG. 4, a recess 32 corresponding to the thickness of the layer has been formed on the flattened outer section 6, in which recess the low-friction material 30 forming the sliding surface has been applied more or less in a flush-mounted manner. The low-friction material 30 forming the sliding surface then forms the mount for the displacer element, which is not shown, of an injection pump.

In the opening 4 of the cam ring 2, as previously described in connection with FIGS. 1 to 3, an inventive low-friction material that forms a sliding surface can be provided, or there can be a conventional, plain, bearing bushing here, which is molded out of a composite material. By providing the flattened outer section 6 a with a low-friction material 30 that forms a sliding surface and is applied directly to the steel of the cam ring 2, the arching of the cam ring has less negative effects than it would, if the displacement element rested directly against the steel surface of the flattened outer section 6 of the cam ring 2.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A cam ring (2) for an injection pump for an internal combustion engine with a round opening (4) for an eccentrically driven shaft section, and with at least one flattened outer section (6), against which a displacement element of the injection pump can rest, whereby in the opening (4) of the cam ring (2), a bushing-shaped, low-friction bearing means is provided for mounting the shaft section, characterized in that the low-friction bearing means (12) comprises a polymer-based sliding-layer material with friction-reducing materials (14) that forms the sliding surface, which is applied directly to the surface (16) delimiting the opening (4) of the cam ring (2).

2. The cam ring according to claim 1, characterized in that the sliding-layer material (14) is sprayed onto the surface.

3. The cam ring according to claim 1, characterized in that the sliding-layer material (14) is prepared as a film-like substance and applied to the surface.

4. The cam ring according to claim 1, characterized in that the surface (16) features a surface roughness of at least R_{z}4.

5. The cam ring according to claim 1, characterized in that the sliding-surface material (14) is PEEK-based.

6. The cam ring according to claim 1, characterized in that the sliding-surface material (14) is comprised of about 5 to about 15 percent by weight of TiO₂.

7. The cam ring according to claim 1, characterized in that the sliding-surface material (14) is comprised of about 5 to about 15 percent by weight of ZnS.

8. The cam ring according to claim 1, characterized in that the sliding-surface material (14) is comprised of about 5 to about 15 percent by weight of graphite.

9. The cam ring according to claim 1, characterized in that the sliding-surface material (14) is comprised of about 5 to about 15 percent by weight of carbon fibers.

10. The cam ring according to claim 1, characterized in that the layer of sliding-surface material (14) has a thickness of about 100 to about 250 μm.

11. The cam ring according to claim 1, characterized in that the sliding-surface material (14) includes a PAI-based lubricating varnish.

12. The cam ring according to claim 1, characterized in that the layer of sliding-surface material (14) has a thickness of about 15 to about 40 μm.

13. The cam ring according to claim 1, characterized in that the surface (16) delimiting the opening (4) of the cam ring (2) features macroscopic surface contouring (20) that forms undercuts in a circumferential direction.

14. The cam ring according to claim 13, characterized in that the surface contouring (20) comprises at least one of groove-shaped recesses (22) and webbed elevations.

15. The cam ring according to claim 13, characterized in that the surface contouring (20) comprises a knurled pattern (24).

16. The cam ring according to claim 1, characterized in that on the flattened outer section (6), a polymer-based sliding-layer material (30) is provided, which is applied directly to a surface of the cam ring (2), said sliding-layer material essentially forming a bearing surface for the displacement element.

17. The cam ring according to claim 16, characterized in that the sliding-layer material (30) is applied in a layer with a thickness of about 100 to about 250 μm.
